(19) United States
(12) Patent Application Publication
(10) Pub. No.: US 2014/0057194 A1
(43) Pub. Date: Feb. 27, 2014

(54) PROTON EXCHANGE MEMBRANE FUEL CELL WITH STEPPED CHANNEL BIPOLAR PLATE

(71) Applicant: FORD GLOBAL TECHNOLOGIES, LLC, Dearborn, MI (US)

(72) Inventor: Daniel E. Wilkosz, Saline, MI (US)

(73) Assignee: FORD GLOBAL TECHNOLOGIES, LLC, Dearborn, MI (US)

(21) Appl. No.: 13/833,348

(22) Filed: Mar. 15, 2013

Related U.S. Application Data
(63) Continuation-in-part of application No. 13/593,562, filed on Aug. 24, 2012.

(51) Int. Cl. H01M 8/02

(52) U.S. Cl. CPC H01M 8/0254
USPC 429/457

(57) ABSTRACT

A fuel cell stack includes a membrane electrode assembly and a bipolar plate. The bipolar plate has a corrugated portion defined by an adjacent pair of proximal and distal peak portions and a sidewall segment connecting the peak portions. The sidewall segment and membrane electrode assembly at least partially define a flow channel. The sidewall segment includes a shoulder portion defining a step spaced away from the peak portions.

### CROSS-REFERENCE TO RELATED APPLICATION

This application is a continuation-in-part of application Ser. No. 13/593,562, filed Aug. 24, 2012, the disclosure of which is incorporated in its entirety by reference herein.

### TECHNICAL FIELD

This disclosure relates to proton exchange membrane (PEM) fuel cells and to the construction and arrangement of bipolar plates therein.

### BACKGROUND

A proton exchange membrane fuel cell is an electrochemical energy conversion device that converts hydrogen and oxygen into water, and in the process produces electricity. Hydrogen fuel is channeled through flow fields to an anode on one side of the fuel cell. Oxygen (from the air) is channeled through flow fields to a cathode on the other side of the fuel cell. At the anode, a catalyst causes the hydrogen to split into hydrogen ions and electrons. A polymer electrolyte membrane disposed between the anode and cathode allows the positively charged ions to pass through it to the cathode. The electrons travel through an external circuit to the cathode, which creates an electrical current. At the cathode, the hydrogen ions combine with the oxygen to form water, which flows out of the cell.

### SUMMARY

A fuel cell stack includes a membrane electrode assembly and a pair of bipolar plates in contact with each other. Each of the bipolar plates includes peak portions and sidewalls connecting the peak portions. Each of the sidewalls and the membrane electrode assembly at least partially defining a flow channel. Each of the sidewalls of at least one of the bipolar plates including end portions and a body portion disposed between the end portions. Each of the end portions being adjacent to one of the peak portions. Each of the body portions including at least one stepped shoulder portion.

A vehicle includes a fuel cell stack arranged to provide power to move the vehicle. The fuel cell stack includes a membrane electrode assembly and a plurality of bipolar plates. Each of the bipolar plates includes peak portions and sidewalls connecting the peak portions. Each of the sidewalls and the membrane electrode assembly at least partially defining a flow channel. At least some of the flow channels have a width and a depth greater than the width. Each of the sidewalls of at least one of the bipolar plates includes end portions and a body portion disposed between the end portions. Each of the end portions is adjacent to one of the peak portions. At least some of the body portions include at least one stepped shoulder portion.

A fuel cell stack includes a plurality of corrugated bipolar plates each defined by peak portions and sidewalls connecting the peak portions. At least some of the sidewalls include a stepped shoulder portion. The sidewalls of one of the bipolar plates are in contact with the sidewalls of another of the bipolar plates to form a nested pair of bipolar plates.

### BRIEF DESCRIPTION OF THE DRAWINGS

FIG. 1 is a diagrammatic cross-sectional view of a bipolar plate flow channel. Channel width is labeled with a “W” and channel depth is labeled with a “D.”

FIG. 2 is a diagrammatic cross-sectional view of a conventional bipolar plate flow channel having a trapezoidal shape.

FIG. 3 is a diagrammatic cross-sectional view of a fuel cell stack disposed within a vehicle and including bipolar plates having flow channels defined at least partially by stepped sidewalls.

FIG. 4 is a diagrammatic cross-sectional view of a bipolar plate having flow channels at least partially defined by stepped sidewalls.

FIG. 5 is a diagrammatic cross-sectional view of a bipolar plate flow channel. The channel depth is at least equal to the channel width. Like numbered elements among the various figures can have similar descriptions.

FIG. 6 is a diagrammatic cross-sectional view of a bipolar plate flow channel. The sidewalls each include two shoulder projections.

FIG. 7 is a diagrammatic cross-sectional view of a junction between two adjacent fuel cells of a fuel cell stack. The bipolar plates are in contact with each other. One of the bipolar plates has flow channels at least partially defined by stepped sidewalls. The other of the bipolar plates has flow channels which are trapezoidal in shape.

FIG. 8 is a diagrammatic cross-sectional view of a junction between two adjacent fuel cells of a fuel cell stack including a centerplate disposed between and in contact with bipolar plates of the fuel cells.

FIG. 9 is a diagrammatic cross-sectional view of a junction between two adjacent fuel cells of a fuel cell stack. The bipolar plates are at least partially nested with each other. One of the bipolar plates has flow channels at least partially defined by stepped sidewalls. The other of the bipolar plates has flow channels which are trapezoidal in shape.

FIG. 10 is a diagrammatic cross-sectional view of a junction between two adjacent fuel cells of a fuel cell stack. The bipolar plates are at least partially nested with each other. Both of the bipolar plates have flow channels at least partially defined by stepped sidewalls.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Candidate metallic bipolar plate (MBPP) materials can be formed into a series of channels having widths and depths designed to satisfy desired fuel cell performance criteria. To increase fuel cell performance, deep, narrow channels with vertical side wall geometries essentially mimicking a flat bottom “U” are preferred in certain circumstances. Such geometries, however, can be difficult or impossible to form from thin metallic materials in a cost effective manner. Formability limits of certain thin metallic materials, such as stainless steel foil, can thus restrict their usage as MBPP materials for fuel cell applications. For example, stamping deep, straight channels into thin metallic materials can produce excessive material thinning at channel geometry transition regions such as at channel edges. Such thinning can result in tearing of the plate during channel formation, assembly of the fuel cell, or operation of the fuel cell stack. Moreover, to the extent that the bipolar plate is a structural component of the fuel cell stack, such thinning can compromise the rigidity of the bipolar plate.

Conventional MBPP designs commonly feature channels with cross-sections resembling a flat-bottom “V” (or trapezoidal shape). These configurations tend to have moderate side wall angles and restricted channel depths in an effort to accommodate the forming limits of the precursor plate material and to minimize strain-induced thinning during the forming process. In some cases, base alloy processing steps can be altered to improve the ability of MBPP precursor materials to form past their normal limits. Alteration of the material base chemistry or manufacturing process, however, can detrimentally impact other characteristics desired of an alloy to be used in fuel cell applications such as corrosion resistance and electrical conductivity. Changes in material composition and processing can also be cost prohibitive.

In fuel cells, increasing flow channel cross-sectional area, particularly on the cathode side of the respective membrane electrode assembly (MEA), can substantially increase fuel cell performance. If the channel opening is too wide, however, the MEA can bow inward toward the channel. For this reason, it could be preferable for the channels to be formed with narrower openings and deeper channels.

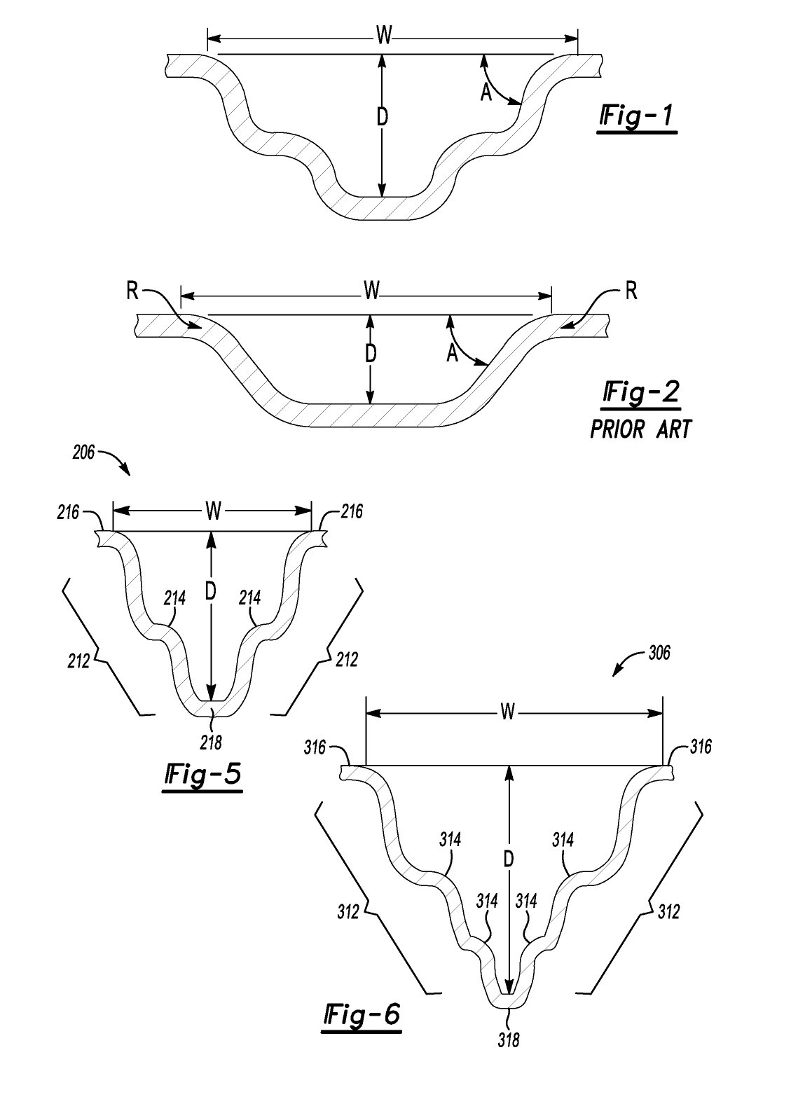

The ability to form MBPPs with deeper channels, particularly when the channels are formed by a stamping process, can be improved by altering the forming limits of the precursor plate material at the expense of other characteristics as mentioned above. It has been discovered, however, that altering channel geometry to accommodate the inherent forming limits of the selected precursor material can also improve the ability to form MBPPs with deeper channels without significantly impacting such characteristics as corrosion resistance and electrical conductivity. Disclosed herein are examples of “stepped” sidewall MBPP channel geometries as shown, for example, in FIG. 1. Flow channels with stepped sidewalls can be distinguished from the more traditional trapezoidal channel configuration shown in FIG. 2.

The segments of the sidewall forming the shoulder (or step) need not form a 90 degree angle relative to each other. Any suitable angle (e.g., 80 degrees, 100 degrees, etc.) that permits deep channel formation without significant thinning can be used. Testing and/or simulation can determine optimum step dimensions.

Finite element analysis (FEA) of the stepped sidewall geometry (shown, for example, in FIG. 1) has been compared to FEA of a traditional trapezoidal-shaped channel (shown, for example, in FIG. 2) with equivalent depth. This comparison revealed that material thinning of the stepped geometry of FIG. 1 is far less than that of the trapezoidal channel geometry of FIG. 2, and material strain across the stepped sidewall geometry of FIG. 1 is more balanced. The FEA comparison also revealed that for the equivalent channel depth, D, the trapezoidal channel of FIG. 2 is more likely to experience material failure in its highly strained upper radius zones, R. The FEA model results have been empirically verified in further studies. Usage of the stepped sidewall geometry similar to that illustrated in FIG. 1 could allow for deeper channels with greater sidewall angles, A, to be formed from existing metallic materials while maintaining acceptable channel opening widths W. These two characteristics can result in improved fuel cell stack operational performance without diminishing the structural integrity of interfacing fuel cell stack components.

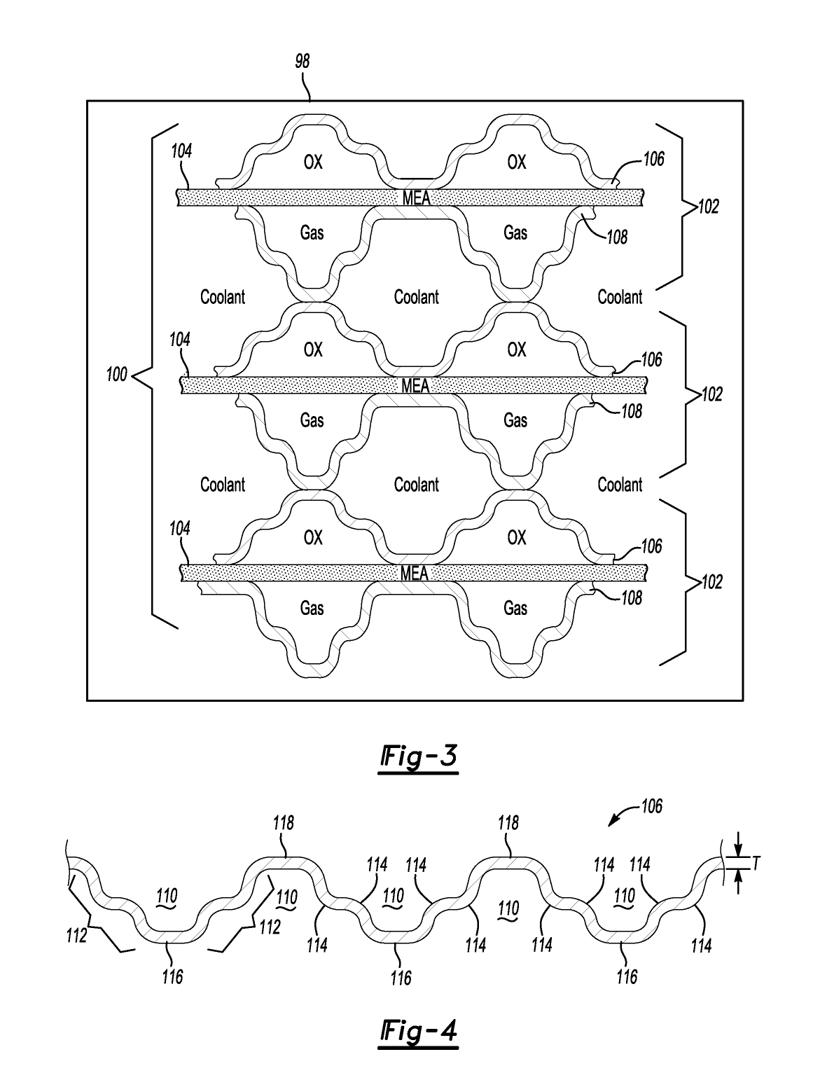

Referring to FIG. 3, a vehicle 98 such as a car can include a fuel cell stack 100 arranged, as known in the art, to provide power to move the vehicle 98. The fuel cell stack 100 can include a plurality of fuel cells 102 electrically connected together. Each of the fuel cells 102 can include a membrane electrode assembly (MEA) 104 disposed between first and second bipolar plates 106, 108. The membrane electrode assembly 104 includes a cathode portion on one side and an anode portion on the other side. Where the term “Gas” is used in the figures, it is intended to represent the fuel of the fuel cell 102 exposed to the anode side of the MEA 104. In a hydrogen fuel cell, for example, the Gas would be hydrogen gas. Where the term “OX” is used in the figures, it is intended to represent oxygen (or air containing oxygen) exposed to the cathode side of the MEA 104.

Referring to FIG. 4, each of the bipolar plates 106 can be stamp-formed from a precursor metal sheet such as a sheet of stainless steel foil or other appropriate conductive metallic material. Alternative forming methods such as hydro-forming and adiabatic forming can also be used. Each of the bipolar plates 106 defines adjacently aligned flow channels 110 (normal to the page) alternately disposed on opposing sides of the bipolar plate 106. Further, each of the bipolar plates 106 includes at least partially stepped sidewalls 112 having shoulder portions 114, and proximal and distal peak portions 116, 118 where the stepped sidewalls 112 connect with each other (giving the bipolar plate 106 a corrugated appearance). Hence, each of the stepped sidewalls 112, in this example, have two end portions and a body portion disposed between the end portions. Each of the end portions is adjacent to one of the peak portion 116, 118. The shoulder portions 114 are formed in the body portions. The proximal peak portions 116 of each bipolar plate 106 can be in direct contact with the MEA 104 (FIG. 3). The distal peak portions 118 of adjacent bipolar plates can be aligned and in electrical contact with one another.

Particularly in instances in which the bipolar plates 106 are stamp-formed, the bipolar plates 106 can have a substantially uniform web thickness, T. Such thickness can be, for example, in the range of approximately 100 microns. Any suitable thickness, however, can be used (e.g., 80 to 250 microns, etc.) A similar description applies to the bipolar plates 108 of FIG. 3.

Referring to FIG. 5, a portion of a bipolar plate 206 includes at least partially stepped sidewalls 212 having shoulder portions 214 and proximal and distal peak portions 216, 218 respectively. The channel depth, D, in this example, is at least as equal to the channel width, W. In other examples, the channel depth, D, can be greater than the channel width, W. For example, D can be approximately 500 microns and W can be approximately 100 microns.

Referring to FIG. 6, a portion of a bipolar plate 306 includes at least partially stepped sidewalls 312 having shoulder portions 314 and proximal and distal peak portions 316, 318 respectively. In this example, each of the stepped sidewalls 312 can have two (or more) shoulder portions 114. Other configurations are also contemplated.

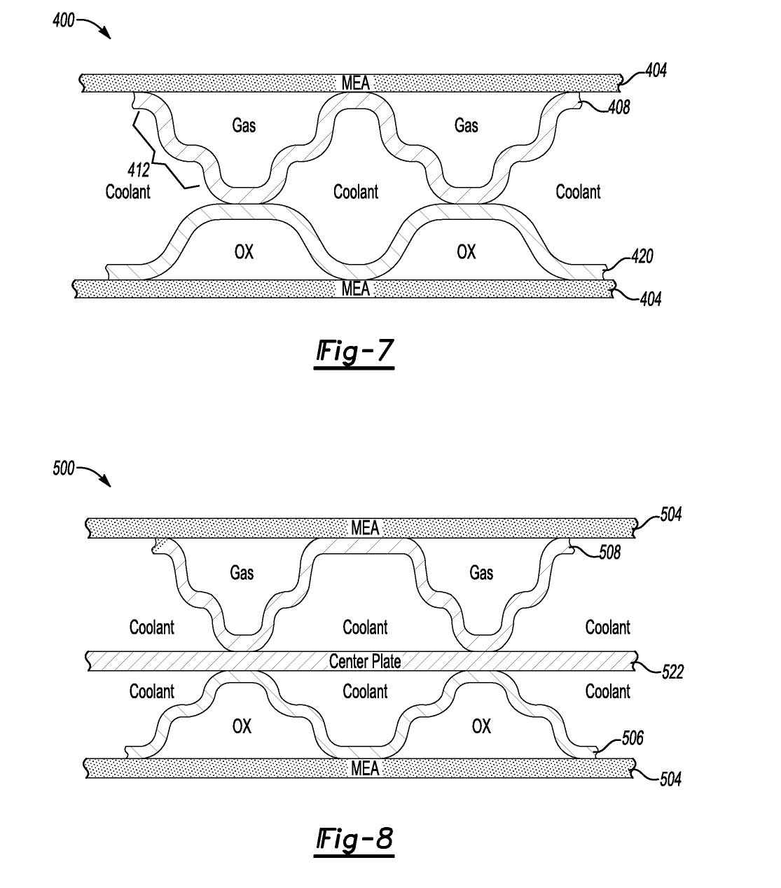

Referring to FIG. 7, a portion of a fuel cell stack 400 includes MEAs 404 and bipolar plates 408, 420 in contact with each other and disposed between the MEAs 404. In this example, the bipolar plate 408 includes stepped sidewalls 412 and the bipolar plate 420 does not.

Referring to FIG. 8, a portion of a fuel cell stack 500 includes MEAs 504, bipolar plates 506, 508, and a center plate 522. The center plate 522 is disposed between and in contact with the bipolar plates 506, 508 to prevent nesting of adjacent bipolar plates and to increase the number of coolant flow channels associated with the bipolar plates 506, 508. Other arrangements are also contemplated.

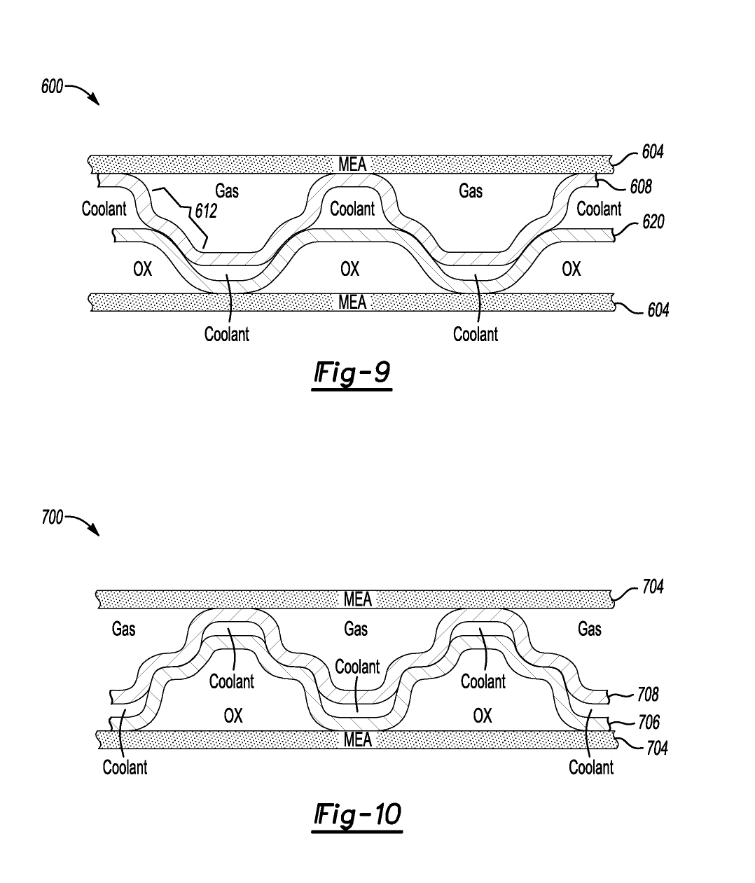

Referring to FIG. 9, a portion of a fuel cell stack 600 includes MEAs 604 and bipolar plates 608, 620. Similar to the example of FIG. 7, the bipolar plate 608 includes stepped sidewalls 612 and the bipolar plate 620 does not. The bipolar plates 608, 620 are arranged such that their sidewalls are in contact with each other (e.g., connected via welding, bonding, etc.), which can increase surface contact (and electrical conductivity) therebetween, provide alternative weld locations, and decrease stack height.

Referring to FIG. 10, a portion of a fuel cell stack 700 includes MEAs 705 and bipolar plates 706, 708. Similar to the example of FIG. 9, the bipolar plates 706, 708 are arranged such that their sidewalls are in contact with each other to form a nested pair.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments may have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to: cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A fuel cell stack comprising:
a membrane electrode assembly; and
a pair of bipolar plates in contact with each other, each of the bipolar plates including peak portions and sidewalls connecting the peak portions, each of the sidewalls and the membrane electrode assembly at least partially defining a flow channel, each of the sidewalls of at least one of the bipolar plates including end portions and a body portion disposed between the end portions, each of the end portions being adjacent to one of the peak portions, and each of the body portions including at least one stepped shoulder portion.

2. The fuel cell stack of claim 1 wherein the peak portions of one of the bipolar plates are connected to the peak portions of the other of the bipolar plates.

3. The fuel cell stack of claim 1 wherein the sidewalls of one of the bipolar plates are in contact with the sidewalls of the other of the bipolar plates.

4. The fuel cell stack of claim 1 wherein each of the flow channels has a width and at least some of the flow channels have a depth greater than the width.

5. The fuel cell stack of claim 1 wherein the at least one bipolar plate has a generally uniform thickness.

6. The fuel cell stack of claim 1 wherein a thickness of the at least one bipolar plate is approximately 100 microns.

7. The fuel cell stack of claim 1 wherein the at least one bipolar plate is formed from metal.

8. The stack of claim 7 wherein the at least one bipolar plate is formed from stainless steel foil.

9. A vehicle comprising:
a fuel cell stack arranged to provide power to move the vehicle and including a membrane electrode assembly and a plurality of bipolar plates, each of the bipolar plates including peak portions and sidewalls connecting the peak portions, each of the sidewalls and the membrane electrode assembly at least partially defining a flow channel, at least some of the flow channels having a width and a depth greater than the width, each of the sidewalls of at least one of the bipolar plates including end portions and a body portion disposed between the end portions, each of the end portions being adjacent to one of the peak portions, and at least some of the body portions including at least one stepped shoulder portion.

10. The vehicle of claim 9 wherein the peak portions of one of the bipolar plates are connected to the peak portions of another of the bipolar plates.

11. The vehicle of claim 9 wherein the sidewalls of one of the bipolar plates are in contact with the sidewalls of another of the bipolar plates.

12. The vehicle of claim 9 wherein the bipolar plates are formed from metal.

13. The vehicle of claim 12 wherein the bipolar plates are formed from stainless steel foil.

14. A fuel cell stack comprising:
a plurality of corrugated bipolar plates each defined by peak portions and sidewalls connecting the peak portions, at least some of the sidewalls including a stepped shoulder portion, and the sidewalls of one of the bipolar plates being in contact with the sidewalls of another of the bipolar plates to form a nested pair of bipolar plates.

15. The fuel cell stack of claim 14 wherein the bipolar plates are formed from metal foil.

16. The fuel cell stack of claim 14 wherein at least some of the bipolar plates have a generally uniform thickness.
